(19) United States
(12) Patent Application Publication
(10) Pub. No.: US 2012/0011421 A1
(43) Pub. Date: Jan. 12, 2012

(54) FAIL ANALYSIS SYSTEM AND METHOD FOR SEMICONDUCTOR DEVICE

(76) Inventors: Mami KODAMA, Yokohama-Shi (JP); Yoshikazu Iizuka, Kawasaki-Shi (JP); Masaki Yoshimura, Kawasaki-shi (JP)

(21) Appl. No.: 12/974,612

(22) Filed: Dec. 21, 2010

(30) Foreign Application Priority Data
Jul. 7, 2010 (JP) 2010-154968

(51) Int. Cl. G06F 11/07

(52) U.S. Cl. 714/799; 714/E11.025

(57) ABSTRACT

According to one embodiment, a fail analysis system performs mesh division of a physical fail bit map and stores fail bit map image data of a part bit fail region in a first image data storage region while classifying the fail bit map image data in each contraction ratio, in each chip, and in each layer. The fail analysis system also stores the fail bit map image data in a second image data storage region while classifying the fail bit map image data in each kind of a fail mode, in each contraction ratio, in each chip, and in each layer. Further, based on an instruction of a display format and/or a display region from a user, the fail analysis system extracts the pieces of fail bit map image data from the first image data storage region or second image data storage region to combine the pieces of fail bit map image data, and displays the combined fail bit map image data on a display unit.

### CROSS REFERENCE TO RELATED APPLICATION

This application is based upon and claims benefit of priority from the Japanese Patent Application No. 2010-154968, filed on Jul. 7, 2010, the entire contents of which are incorporated herein by reference.

### FIELD

Embodiments described herein relate generally to a fail analysis system and a fail analysis method for a semiconductor device.

### BACKGROUND

There is a fail analysis method in which a fail bit map is used as one of fail analysis methods for a semiconductor memory including plural memory cells. In the fail bit map, an electric characteristic test is performed to all the memory cells with a tester, and the test result is displayed in a position corresponding to each memory cell.

In the fail bit map, data of one chip is stored while compressed in one file. However, a data size of the fail bit map is enlarged with finer design rule and higher integration of the semiconductor memory. As a result, the fail bit map cannot be retained in a computer memory when the data compressed in one file is expanded, and swap is generated to decrease a data access rate. When the data access rate is decreased, a time to display the fail bit map is lengthened, which results in a problem in that inspection cost of the semiconductor device is increased.

In fail analysis of a semiconductor memory having a three-dimensional structure, it is necessary that the fail bit maps in various display forms be displayed while switched. Examples of the display form include the fail bit map on a surface in which the semiconductor memory is sliced along a horizontal direction of the wafer surface, the fail bit map on a surface in which the semiconductor memory is sliced along a direction perpendicular to the wafer surface, and the fail bit map of three-dimensional display. Accordingly, the lengthened time to display the fail bit map contributes largely to the increase of the inspection cost of the semiconductor device.

### BRIEF DESCRIPTION OF THE DRAWINGS

FIG. 1 is a diagram illustrating a schematic configuration of a fail analysis system according to an embodiment of the invention;

FIG. 2 is a diagram illustrating a schematic configuration of a three-dimensional structure memory;

FIG. 3 is a diagram illustrating an example of mesh division of a chip;

FIG. 4 is a diagram illustrating an example of a divided region to which an identification number is provided;

FIG. 5 is a diagram illustrating an example of contraction processing;

FIG. 6 is a diagram illustrating an example of a directory structure of a first image data storage region;

FIG. 7 is a diagram illustrating an example of the image data storage of the first image data storage region;

FIG. 8 is a diagram illustrating an example of management information;

FIG. 9 is a flowchart for explaining data processing performed by a fail bit data creating unit;

FIG. 10 is a diagram illustrating an example of a directory structure of a second image data storage region;

FIG. 11 is a diagram illustrating an example of image data storage of the second image data storage region;

FIG. 12 is a diagram illustrating an example of management information;

FIG. 13 is a diagram illustrating an example of a toggle button that switches a displayed layer and a displayed fail mode;

FIG. 14 is a diagram illustrating an example of display switching of a fail bit map image;

FIG. 15 is a diagram illustrating an example of the display switching of the fail bit map image; and

FIG. 16 is a diagram illustrating an example of a toggle button that switches a displayed layer and a displayed fail mode.

### DETAILED DESCRIPTION

According to one embodiment, a fail analysis system performs mesh division of a physical fail bit map and stores fail bit map image data of a part bit fail region in a first image data storage region while classifying the fail bit map image data in each contraction ratio, in each chip, and in each layer. The fail analysis system also stores the fail bit map image data in a second image data storage region while classifying the fail bit map image data in each kind of a fail mode, in each contraction ratio, in each chip, and in each layer. Further, based on an instruction of a display format and/or a display region from a user, the fail analysis system extracts the pieces of fail bit map image data from the first image data storage region or second image data storage region to combine the pieces of fail bit map image data, and displays the combined fail bit map image data on a display unit.

Hereafter, an embodiment of the present invention will be described with reference to the drawings.

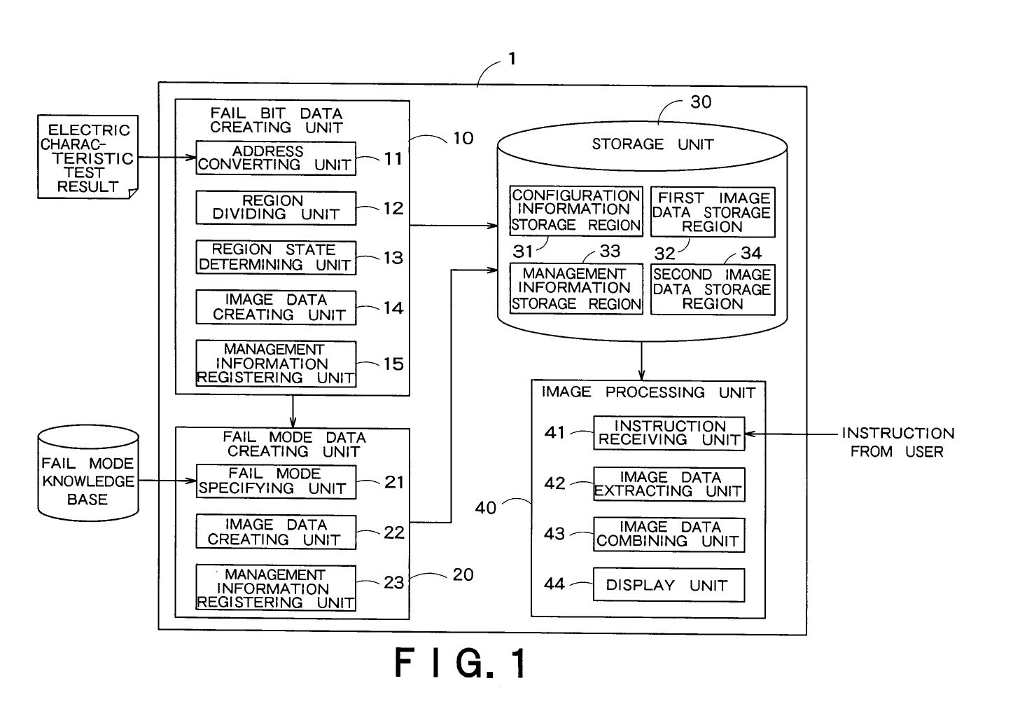

FIG. 1 illustrates a schematic configuration of a fail analysis system 1 according to an embodiment of the invention. The fail analysis system 1 includes a fail bit data creating unit 10, a fail mode data creating unit 20, a storage unit 30, and an image processing unit 40. In the embodiment, it is assumed that the fail analysis system 1 performs fail analysis of a memory having a three-dimensional structure.

First, the fail bit data creating unit 10 will be described. The fail bit data creating unit 10 includes an address converting unit 11, a region dividing unit 12, a region state determining unit 13, an image data creating unit (first image data creating unit) 14, and a management information registering unit 15.

The address converting unit 11 obtains test result (pass/fail information on memory cell) of an electric characteristic test for a memory to be a fail analysis target from an external tester. The test result is in the form of a logical fail bit map corresponding to a logical address of the memory.

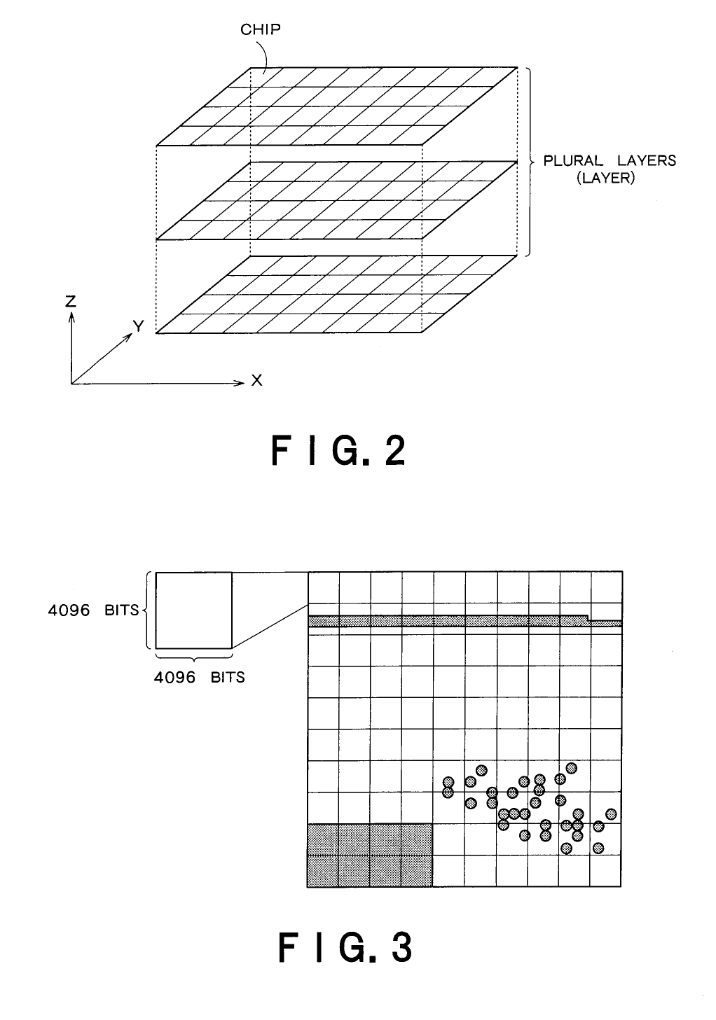

The address converting unit 11 obtains physical configuration information on the memory to be the fail analysis target from a configuration information storage region 31 of the storage unit 30. The address converting unit 11 converts the logical address of the memory into a physical address based on the configuration information on the memory. That is, the address converting unit 11 converts the logical fail bit map into a physical fail bit map corresponding to a cell array of the memory, thereby obtaining the physical fail bit map of the memory having a three-dimensional structure illustrated in FIG. 2.

In FIG. 2, an XY-plane is parallel to a wafer surface, and a Z-axis is perpendicular to the wafer surface. The physical fail bit map includes plural layers, and each layer includes plural chips.

The address converting unit 11 outputs the physical fail bit map after the address conversion to the region dividing unit 12.

The region dividing unit 12 divides the physical fail bit map received from the address converting unit 11 into predetermined small regions. For example, as illustrated in FIG. 3, the region dividing unit 12 performs mesh division of the physical fail bit map corresponding to each chip into 4096-bit-by-4096-bit small regions. In FIG. 3, a fail bit is illustrated in black.

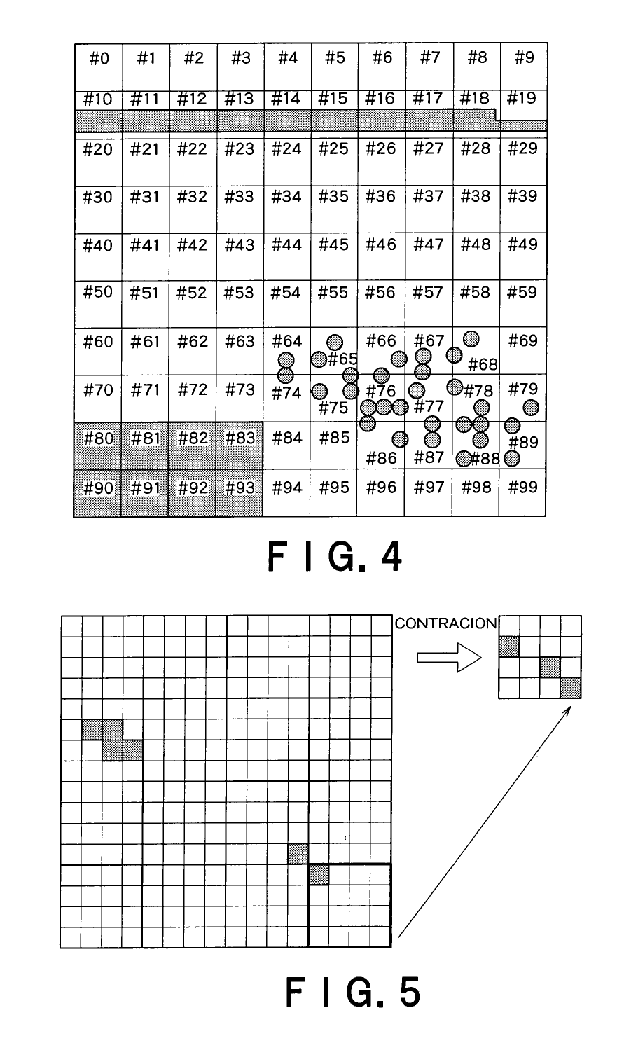

The region dividing unit 12 also provides an identification number to the divided region (small region). For example, when one chip is divided into 100 small regions as illustrated in FIG. 4, the region dividing unit 12 provides the identification numbers #0 to #99 to the 100 small regions sequentially.

The region dividing unit 12 also detects whether the fail bit exists in each divided region. When the fail bit does not exist in each divided region, the region dividing unit 12 sets a flag. For example, when the fail bits exist as illustrated in FIG. 4, the region dividing unit 12 sets the flags in the divided regions having the identification numbers #10 to #19, #64 to #68, #74 to #83, and #86 to #93.

The region dividing unit 12 performs the above-described processing to all the chips in all the layers.

The region state determining unit 13 determines whether the fail bit does not exist, all the bits are the fail bits, or some bits are the fail bits (fail bit and normal bit exist) in each divided region divided by the region dividing unit 12.

Hereinafter, the divided region where the fail bit does not exist is referred to as a non-fail region, the divided region where all the bits are the fail bits is referred to as a whole bit fail region, and the divided region where some bits are the fail bits is referred to as a part bit fail region.

For example, the region state determining unit 13 determines the divided region where the flag is not set by the region dividing unit 12 as the non-fail region. The region state determining unit 13 also detects whether all the bits are the fail bits for the divided region where the flag is set by the region dividing unit 12, and determines the divided region is the whole bit fail region or the part bit fail region.

For example, when the fail bits are distributed as illustrated in FIG. 4, the region state determining unit 13 determines the divided regions having the identification numbers #0 to #9, #20 to #63, #69 to #73, #84, #85, and #94 to #99 as the non-fail region. The region state determining unit 13 determines the divided regions having the identification numbers #10 to #19, #64 to #68, #74 to #79, and #86 to #89 as the part bit fail region, and determines the divided regions having the identification numbers #80 to #83 and #90 to #93 as the whole bit fail region.

The image data creating unit 14 creates fail bit map image data corresponding to the divided region that is determined as the part bit fail region by the region state determining unit 13.

The image data creating unit 14 does not create the fail bit map image data for the divided region that is determined as the non-fail region by the region state determining unit 13 and the divided region that is determined as the whole bit fail region. This is because the fail bit map can be displayed in the non-fail region and the whole bit fail region irrespective of the fail bit map image data.

Accordingly, when the fail bits are distributed as illustrated in FIG. 4, the image data creating unit 14 creates the fail bit map image data for only the 25 divided regions having the identification numbers #10 to #19, #64 to #68, #74 to #79, and #86 to #89, which are determined as the part bit fail region by the region state determining unit 13, in the 100 divided regions.

The image data creating unit 14 also performs contraction processing to the fail bit map image data in the part bit fail region to create contraction fail bit map image data. As used herein, the contraction processing means that plural bits in the divided region are compressed into one bit. The use of the contraction fail bit map image data can enhance the display of the fail bit map. In order to securely evaluate the fail, one bit of the post-compression (-contraction) is regarded as the fail bit when even one fail bit exists in the plural bits of the pre-compression (-contraction).

FIG. 5 illustrates an example of the contraction processing. In FIG. 5, 4 bits by 4 bits in the divided region are contracted into one bit. Accordingly, the fail bit map image data in the 4096-bit-by-4096-bit divided region (part bit fail region) becomes the contraction fail bit map image data having a 1024-bit-by-1024-bit size through the contraction processing illustrated in FIG. 5.

The image data creating unit 14 performs the pieces of contraction processing at plural contraction ratios to create plural pieces of contraction fail bit map image data having different contraction ratios. For example, the image data creating unit 14 performs the pieces of contraction processing to the fail bit map image data in the 4096-bit-by-4096-bit divided region at the contraction ratio at which the 4 bits by 4 bits are contracted into one bit, at the contraction ratio at which the 16 bits by 16 bits are contracted into one bit, . . . , and at the contraction ratio at which the 256 bits by 256 bits are contracted into one bit. The image data creating unit 14 also creates the contraction fail bit map image data having the 1024-bit-by-1024-bit size, the contraction fail bit map image data having the 256-bit-by-256-bit size, . . . , and the contraction fail bit map image data having the 16-bit-by-16-bit size. The contraction ratio is appropriately fixed according to the memory size and the like.

Thus, the image data creating unit 14 creates the fail bit map image data and the plural pieces of contraction fail bit map image data having the different contraction ratios for the part bit fail region.

The image data creating unit 14 stores the created fail bit map image data and the plural pieces of contraction fail bit map image data having the different contraction ratios in a first image data storage region 32 of the storage unit 30.

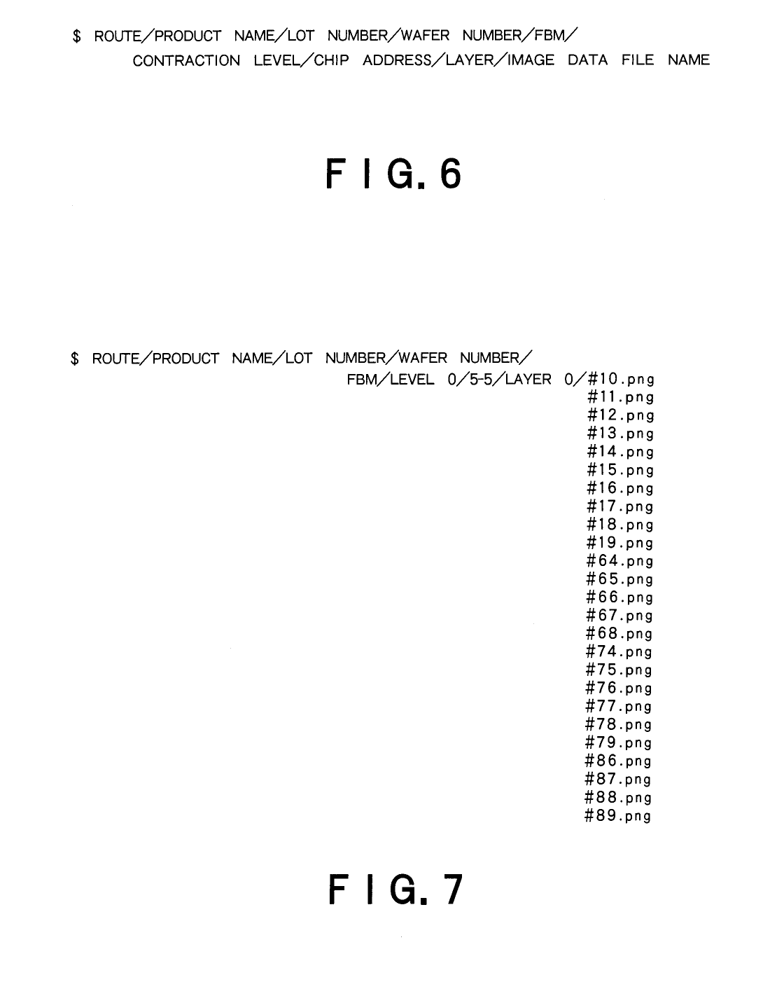

FIG. 6 illustrates an example of a directory structure of the first image data storage region 32 in which the fail bit map image data and the contraction fail bit map image data are stored.

In the directory structure illustrated in FIG. 6, a “contraction level” corresponds to the contraction ratio of the contraction processing. For example, when the image data creating unit 14 performs the contraction processing at three kinds of the contraction ratios, that is, at the contraction ratio at which the 4 bits by 4 bits are contracted into one bit, at the contraction ratio at which the 16 bits by 16 bits are contracted into one bit, and at the contraction ratio at which the 256 bits by 256 bits are contracted into one bit, the fail bit map image data that is not contracted is stored in the directory having the lowest “contraction level 0”, the contraction fail bit map image data in which the 4 bits by 4 bits are contracted into one bit is stored in the directory having the “contraction level 1”, the contraction fail bit map image data in which the 16 bits by 16 bits are contracted into one bit is stored in the directory having “contraction level 2”, and the contraction fail bit map image data in which the 256 bits by 256 bits are contracted into one bit is stored in the directory having the highest “contraction level 3”.

A “chip address” indicates where the chip is located in each layer, and corresponds to an XY-coordinate in FIG. 2. A “layer” indicates which layer the chip is located in, and corresponds to a Z-coordinate in FIG. 2.

For example, when the chip in which the fail bits are distributed as illustrated in FIG. 4 is located in the lowermost layer of the memory while the chip address (X,Y) is (5,5), the fail bit map image data is stored in the first image data storage region 32 in the form illustrated in FIG. 7. The identification number provided to the divided region is used as the image file name.

The management information registering unit 15 of the fail bit data creating unit 10 illustrated in FIG. 1 registers management information (first management information) in a management information storage region 33 of the storage unit 30. Examples of the management information include a product name of the three-dimensional structure memory to be the fail analysis target, a lot number, a wafer number, a chip address, a layer, measurement date and time, the identification number of the non-fail region, the identification number of the whole bit fail region, the identification number of the part bit fail region, and a file name of the fail bit map image data.

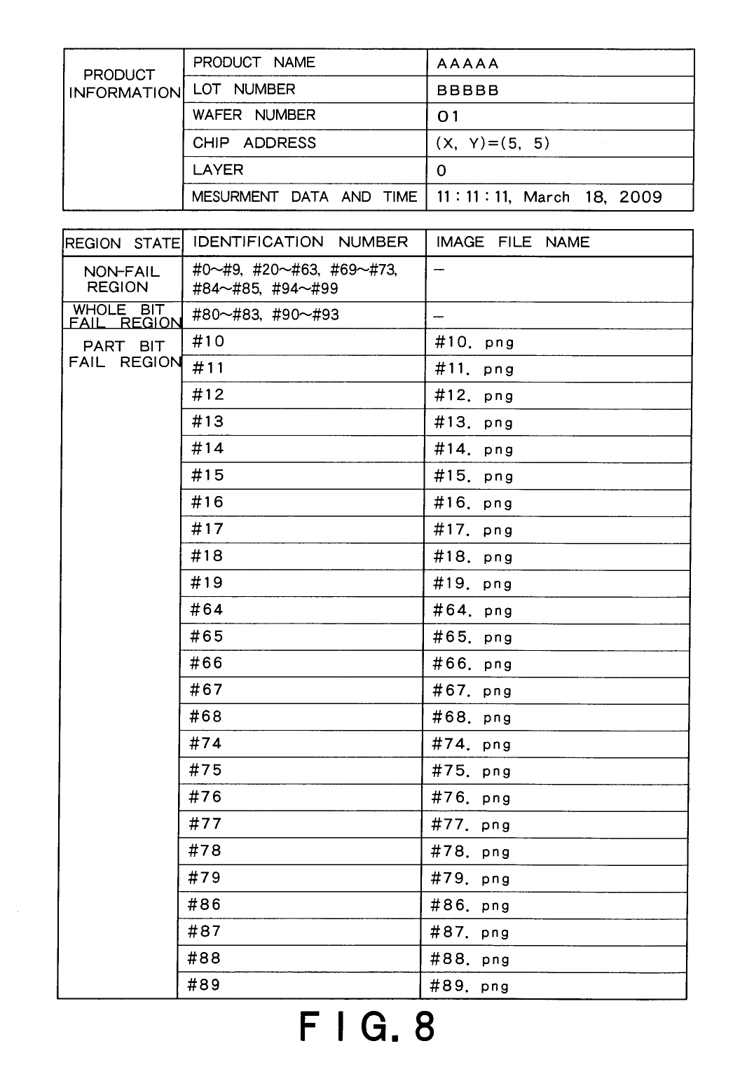

For example, when the chip in which the fail bits are distributed as illustrated in FIG. 4 is located in the lowermost layer of the memory while the chip address (X,Y) is (5,5), the management information illustrated in FIG. 8 is registered in the management information storage region 33.

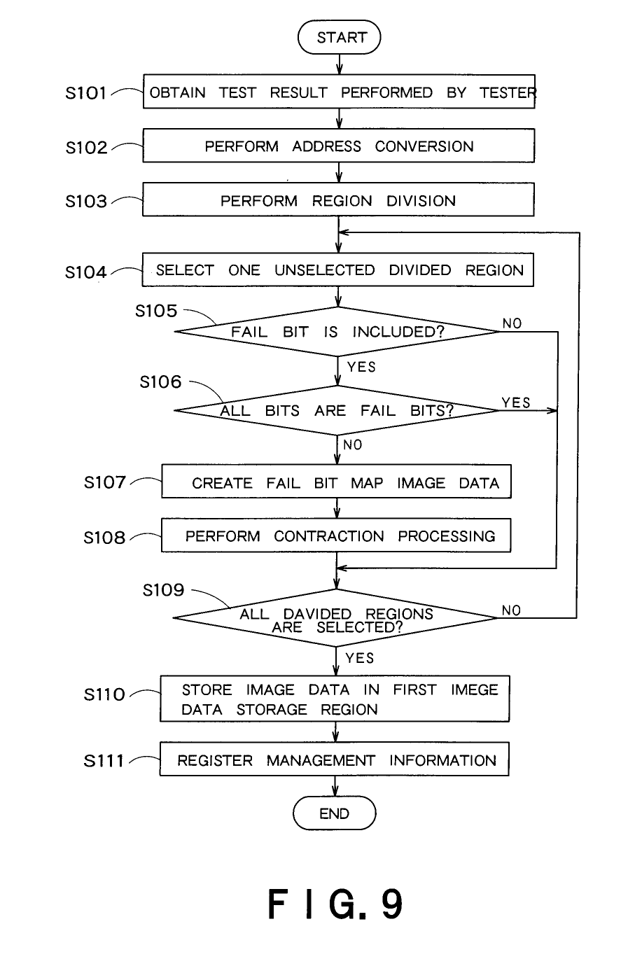

Data processing performed by the fail bit data creating unit 10 will be described with reference to a flowchart illustrated in FIG. 9.

(Step S101) The address converting unit 11 obtains the test result (logical fail bit map) of the electric characteristic test from the external tester for the three-dimensional structure memory to be the fail analysis target.

(Step S102) The address converting unit 11 converts the logical address of the memory into the physical address and converts the logical fail bit map into the physical fail bit map.

(Step S103) The region dividing unit 12 divides the physical fail bit map corresponding to each chip into the predetermined small regions to provide the identification number to the divided region.

(Step S104) The region state determining unit 13 selects one of the unselected divided regions.

(Step S105) The region state determining unit 13 determines whether the fail bit is included in the divided region selected in Step S104. The flow goes to Step S106 when the fail bit is included in the divided region, and the flow goes to Step S109 when the fail bit is not included in the divided region.

(Step S106) The region state determining unit 13 determines whether all the bits in the divided region selected in Step S104 are the fail bits. The flow goes to Step S109 when all the bits are the fail bits, and the flow goes to Step S107 when all the bits are the fail bits.

(Step S107) The image data creating unit 14 creates the fail bit map image data corresponding to the divided region (part bit fail region) selected in Step S104.

(Step S108) The image data creating unit 14 performs the contraction processing to the fail bit map image data, created in Step S107, at the plural contraction ratio to create the contraction fail bit map image data.

(Step S109) The flow goes to Step S110 when all the divided regions are selected, and the flow returns to Step S104 when the unselected divided region exists.

(Step S110) The image data creating unit 14 stores the created fail bit map image data and the contraction fail bit map image data in the first image data storage region 32.

(Step S111) The management information registering unit 15 registers the pieces of management information such as the product name of the three-dimensional structure memory to be the fail analysis target, the lot number, the wafer number, the chip address, the layer, the measurement date and time, and the region state in the management information storage region 33.

Thus, the fail bit data creating unit 10 creates the fail bit map image data and the contraction fail bit map image data for the part bit fail region and registers the pieces of the management information.

Then, the fail mode data creating unit 20 illustrated in FIG. 1 will be described. The fail mode data creating unit 20 includes a fail mode specifying unit 21, an image data creating unit (second image data creating unit) 22, and a management information registering unit 23.

The fail mode specifying unit 21 obtains the physical fail bit map illustrated in FIG. 4, to which the region division and the provision of the identification number are performed, from the region dividing unit 12 of the fail bit data creating unit 10.

The fail mode specifying unit 21 refers to the fail mode knowledge base in which previously-defined various fail modes are stored and specifies a fail mode corresponding to the fail bit from the fail bit distribution shape in the physical fail bit map of each chip. Examples of the fail mode include a single bit fail, a column fail, a row fail, and a block fail.

For example, when the fail bits are distributed as illustrated in FIG. 4, the fail mode specifying unit 21 specifies that the fail bit corresponds to the column fail in the divided regions having the identification numbers #10 to #19. For example, the fail mode specifying unit 21 also specifies that the fail bit is the single bit fail in the divided regions having the identification numbers #64 to #68, #74 to #79, and #86 to #89, and also specifies that the fail bit is the block fail in the divided regions having the identification numbers #80 to #83 and #90 to #93.

The image data creating unit 22 creates the fail bit map image data in the divided regions including the fail bits whose fail modes are specified by the fail mode specifying unit 21. Similarly to the image data creating unit 14 of the fail bit data creating unit 10, the image data creating unit 22 performs the contraction processing to create the contraction fail bit map image data.

The image data creating unit 22 stores the created fail bit map image data and the plural pieces of contraction fail bit map image data having different contraction ratios in a second image data storage region 34 of the storage unit 30.

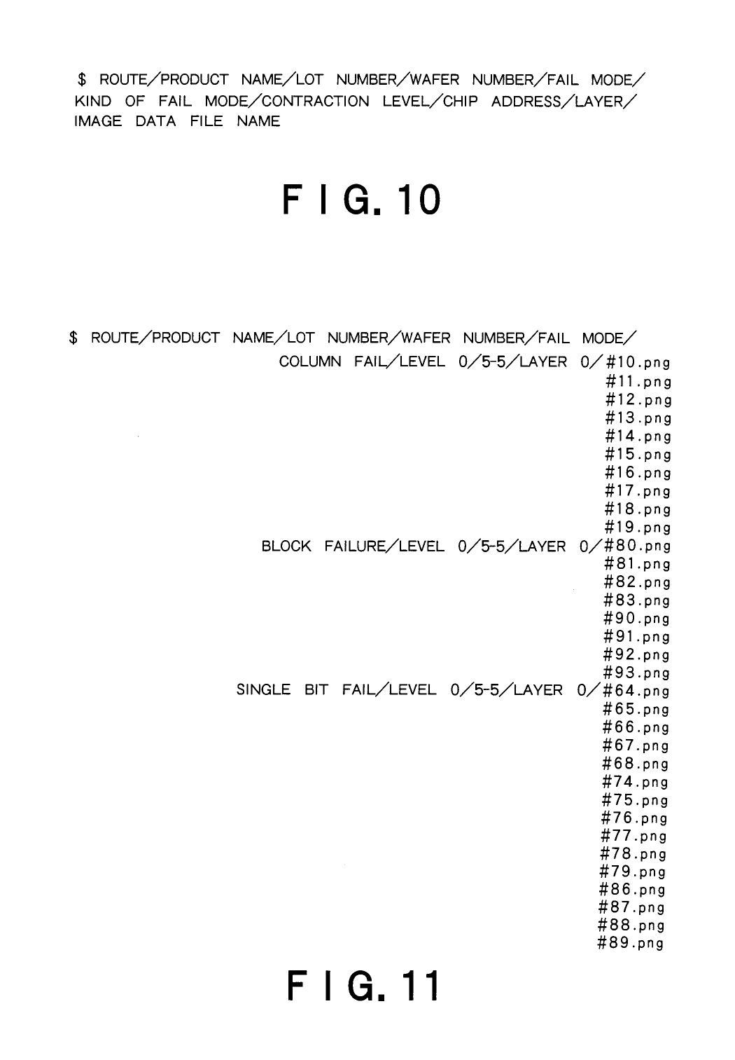

FIG. 10 illustrates an example of a directory structure of the second image data storage region 34 in which the fail bit map image data and the contraction fail bit map image data are stored. The fail bit map image data and the pieces of contraction fail bit map image data are stored in the second image data storage region 34 while a directory used to distinguish the kinds of the fail modes from one another is provided.

For example, when the chip in which the fail bits are distributed as illustrated in FIG. 4 is located in the lowermost layer while the chip address (X,Y) is (5,5), the fail bit map image data can be stored in the second image data storage region 34 in the form illustrated in FIG. 11.

When the fail bits corresponding to the different fail modes exist in one divided region, the image data creating unit 22 creates the fail bit map image data in which only the fail bit corresponding to each fail mode exists, and stores the fail bit map image data in the second image data storage region 34. For example, when the fail bit corresponding to the column fail and the fail bit corresponding to the single bit fail exist in one divided region, the image data creating unit 22 creates the fail bit map image data in which only the fail bit corresponding to the column fail exists, and stores the fail bit map image data in a “column fail” directory of the second image data storage region 34. The image data creating unit 22 also creates the fail bit map image data in which only the fail bit corresponding to the single bit fail exists, and stores the fail bit map image data in a “single bit fail” directory of the second image data storage region 34. Therefore, the display of the fail bit corresponding to another fail mode can be prevented when the fail bit map is displayed in each fail mode.

The management information registering unit 23 registers management information (second management information) in the management information storage region 33 of the storage unit 30. Examples of the management information include the product name of the three-dimensional structure memory to be the fail analysis target, the lot number, the wafer number, the fail mode, the chip address, the layer, measurement date and time, the identification number of the divided region where the fail bit corresponding to the fail mode does not exist, the identification number of the divided region where the fail bit corresponding to the fail mode exists, and the file name of the fail bit map image data.

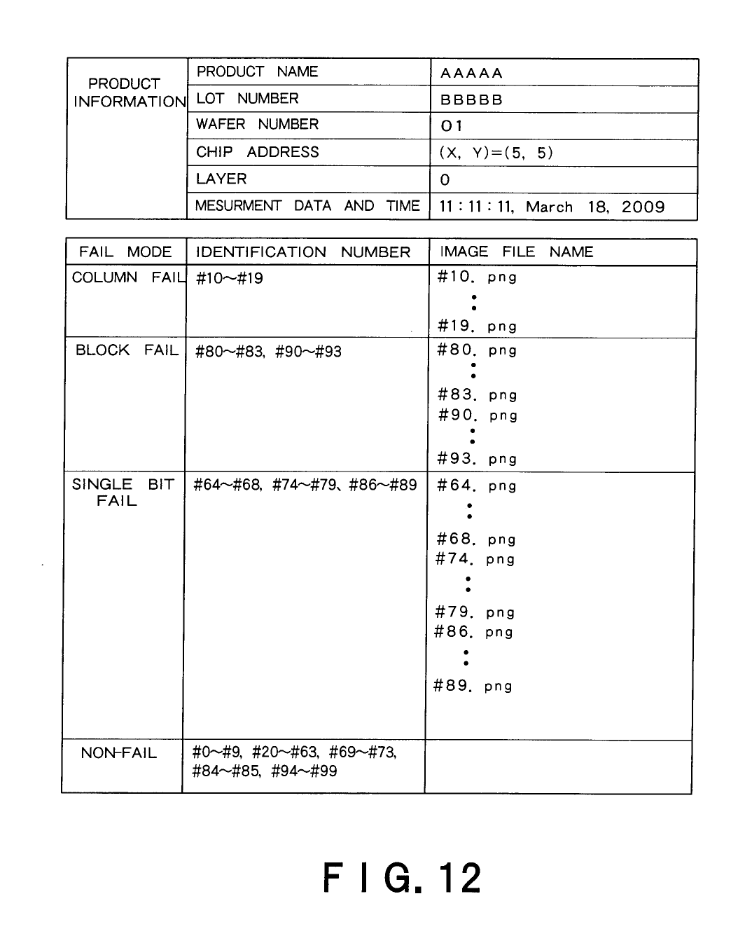

For example, when the chip in which the fail bits are distributed as illustrated in FIG. 4 is located in the lowermost layer while the chip address (X,Y) is (5,5), the management information including a correspondence relationship between the fail mode and the identification number in the divided region is registered in the management information storage region 33 as illustrated in FIG. 12.

Then, the image processing unit 40 illustrated in FIG. 1 will be described. The image processing unit 40 includes an instruction receiving unit 41, an image data extracting unit 42, an image data combining unit 43, and a display unit 44.

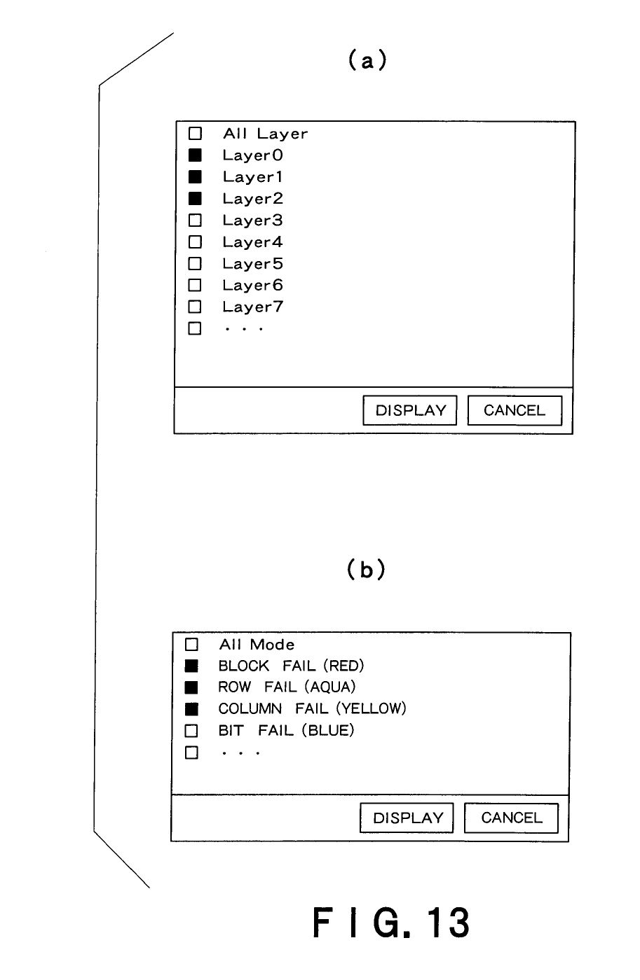

The instruction receiving unit 41 receives an instruction of a display form or a display region of the fail bit map from a user through, for example, a mouse or a keyboard. Examples of the display form of the fail bit map includes two-dimensional display, three-dimensional display, layer-by-layer display, layer overlapping display, fail mode-by-fail mode display, and fail mode overlapping display. For example, as illustrated in FIG. 13(a), a toggle button is displayed on the display unit 44 to select the layer, and the user selects the displayed layer through the instruction receiving unit 41. For example, as illustrated in FIG. 13(b), the toggle button is displayed on the display unit 44 to select the fail mode, and the user selects the displayed fail mode through the instruction receiving unit 41. As illustrated in FIG. 13(b), the display is performed while a color is preferably changed in each fail mode. Therefore, the correspondence relationship between the fail bit and the fail mode is easily recognized when the plural fail modes are displayed.

The instruction receiving unit 41 outputs the display form instruction or display region instruction, received from the user, to the image data extracting unit 42.

The image data extracting unit 42 refers to the management information registered in the management information storage region 33, and extracts the fail bit map image data or contraction fail bit map image data, which is necessary to display the fail bit map, from the first image data storage region 32 or second image data storage region 34 based on the user's instruction obtained from the instruction receiving unit 41.

The image data combining unit 43 creates the fail bit map image by combining the fail bit map image data or contraction fail bit map image data extracted by the image data extracting unit 42, the management information in the management information storage region 33 referred to by the image data extracting unit 42, and the physical configuration information on the memory stored in the configuration information storage region 31.

The display unit 44 displays the fail bit map image created by the image data combining unit 43.

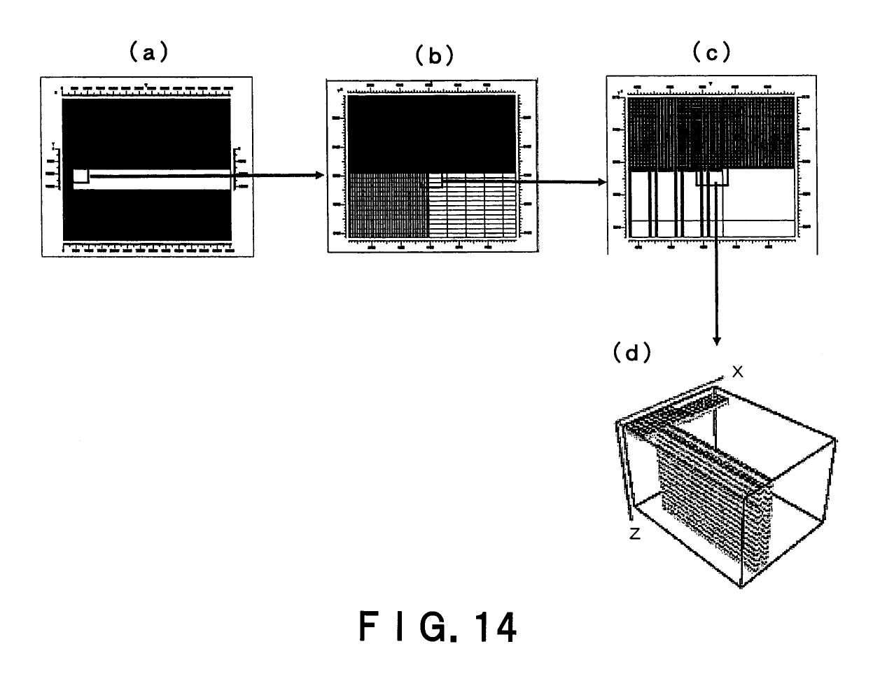

FIG. 14 illustrates an example of display switching of a fail bit map image.

When the user selects the overlapping display (two-dimensional display) of all the layers for one chip of the memory, the image data extracting unit 42 extracts pieces of image data in the part bit fail regions of all the layers included in the directory, which corresponds to the chip address of the selected chip and is located below the directory having the highest contraction level, from the first image data storage region 32. The image data extracting unit 42 refers to the management information to extract the identification number of the non-fail region in the selected chip and the identification number of the whole bit fail region, and notifies the image data combining unit 43 of the identification number of the non-fail region in the selected chip and the identification number of the whole bit fail region.

The image data combining unit 43 creates the image data of the non-fail regions from the identification number of the non-fail regions, creates the image data of the whole bit fail region from the identification number of the whole bit fail region, and combines and overlaps the pieces of image data and the image data of the part bit fail region extracted by the image data extracting unit 42, thereby creating the fail bit map image. Therefore, the display unit 44 displays the fail bit map image illustrated in FIG. 14(a).

When the user provides an instruction to enlarge the desired region in FIG. 14(a), the image data extracting unit 42 extracts pieces of image data in the part bit fail regions of all the layers from the first image data storage region 32. All the layers corresponding to the region assigned by the user are included in the directory, which is located below the directory (for example, “contraction level 1” directory) having the lower contraction level and corresponds to the chip address of the selected chip. The image data extracting unit 42 refers to the management information to extract the identification number of the non-fail region in the region assigned by the user and the identification number of the whole bit fail region, and notifies the image data combining unit 43 of the identification number of the non-fail region and the identification number of the whole bit fail region.

The image data combining unit 43 creates the image data of the non-fail region from the identification number of the non-fail region, creates the image data of the whole bit fail region from the identification number of the whole bit fail region, and combines and overlaps the pieces of image data and the image data of the part bit fail region extracted by the image data extracting unit 42, thereby creating the fail bit map image. Therefore, the display unit 44 displays the fail bit map image illustrated in FIG. 14(b).

When the user provides the instruction to enlarge the desired region in FIG. 14(b), the image data extracting unit 42 extracts the pieces of image data in the part bit fail regions of all the layers from the first image data storage region 32. All the layers corresponding to the region assigned by the user are included in the directory, which is located below the directory (for example, “contraction level 0” directory) having the further lower contraction level and corresponds to the chip address of the selected chip. The image data extracting unit 42 refers to the management information to extract the identification number of the non-fail region in the region assigned by the user and the identification number of the whole bit fail region, and notifies the image data combining unit 43 of the identification number of the non-fail region and the identification number of the whole bit fail region.

Subsequently, the image data combining unit 43 creates the image data of the non-fail region from the identification number of the non-fail region, creates the image data of the whole bit fail region from the identification number of the whole bit fail region, and combines and overlaps the pieces of image data and the image data of the part bit fail region extracted by the image data extracting unit 42, thereby creating the fail bit map image. Therefore, the display unit 44 displays the fail bit map image illustrated in FIG. 14(c).

When the user provides an instruction of the three-dimensional display of the desired region in FIG. 14(c), the image data extracting unit 42 extracts the pieces of image data in the part bit fail regions of all the layers from the first image data storage region 32. All the layers corresponding to the region assigned by the user are included in the directory, which is located below the directory having the identical contraction level and corresponds to the chip address of the selected chip. The image data extracting unit 42 refers to the management information to extract the identification number of the non-fail region in the region assigned by the user and the identification number of the whole bit fail region, and notifies the image data combining unit 43 of the identification number of the non-fail region and the identification number of the whole bit fail region.

The image data combining unit 43 creates the image data of the non-fail region from the identification number of the non-fail region, creates the image data of the whole bit fail region from the identification number of the whole bit fail region, combines the pieces of image data and the image data of the part bit fail region extracted by the image data extracting unit 42 in each layer, and replaces information in each layer with information on a Z-direction (height direction), thereby creating the fail bit map image. Therefore, the display unit 44 three-dimensionally displays the fail bit map image illustrated in FIG. 14(d).

The first image data storage region 32 retains the fail bit map image data in each contraction ratio (contraction level), so that the image data extracting unit 42 can rapidly extract the image data (corresponding to the size of the display region) necessary to display the fail bit map image. Therefore, the display unit 44 can rapidly display the fail bit map image. The first image data storage region 32 retains the fail bit map image data in each layer, so that the image data extracting unit 42 can rapidly extract the image data necessary for the three-dimensional display of the fail bit map image. Therefore, the display unit 44 can rapidly perform the three-dimensional display of the fail bit map image.

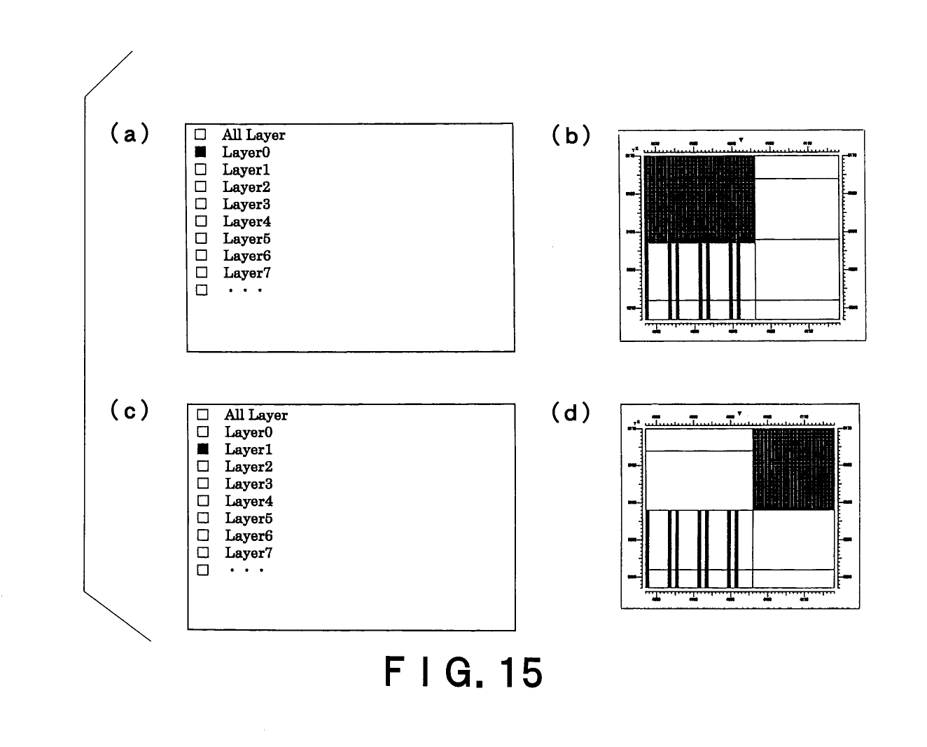

FIG. 15 illustrates another example of the display switching of the fail bit map image.

When the user provides an instruction to display the layer 0 illustrated in FIG. 15(a) while the fail bit map image illustrated in FIG. 14(c) is displayed on the display unit 44, the image data extracting unit 42 extracts the image data of the part bit fail region of the layer 0 from the first image data storage region 32. The layer 0 is included in the directory, which is located below the directory having the identical contraction level and corresponds to the chip address of the selected chip. The image data extracting unit 42 refers to the management information to extract the identification number of the non-fail region in the layer 0 and the identification number of the whole bit fail region, and notifies the image data combining unit 43 of the identification number of the non-fail region and the identification number of the whole bit fail region.

The image data combining unit 43 creates the image data of the non-fail region from the identification number of the non-fail region, creates the image data of the whole bit fail region from the identification number of the whole bit fail region, and combines the pieces of image data and the image data of the part bit fail region extracted by the image data extracting unit 42, thereby creating the fail bit map image. Therefore, the display unit 44 displays the fail bit map image in the layer 0 as illustrated in FIG. 15(b).

When the user provides an instruction to display the layer 1 illustrated in FIG. 15(c), the image data extracting unit 42 extracts the image data in the part bit fail regions of the layer 1 from the first image data storage region 32. The layer 1 is included in the directory, which is located below the directory having the identical contraction level and corresponds to the chip address of the selected chip. The image data extracting unit 42 refers to the management information to extract the identification number of the non-fail region in the layer 1 of the chip and the identification number of the whole bit fail region, and notifies the image data combining unit 43 of the identification number of the non-fail region and the identification number of the whole bit fail region.

The image data combining unit 43 creates the image data of the non-fail region from the identification number of the non-fail region, creates the image data of the whole bit fail region from the identification number of the whole bit fail region, and combines the pieces of image data and the image data of the part bit fail region extracted by the image data extracting unit 42, thereby creating the fail bit map image. Therefore, the display unit 44 displays the fail bit map image in the layer 1 as illustrated in FIG. 15(d).

The first image data storage region 32 retains the fail bit map image data in each layer, so that the image data extracting unit 42 can rapidly extract the image data necessary for the layer-by-layer display of the fail bit map image. Therefore, the display unit 44 can rapidly perform the layer-by-layer display of the fail bit map image.

The user selects the fail mode using the toggle button illustrated in FIG. 13(b), whereby the user can perform the two-dimensional/three-dimensional display of the fail bit map image in each fail mode, or the user can perform the two-dimensional/three-dimensional display by allocating the display color to each fail mode while the plural fail modes are overlapped.

For example, when the user provides an instruction to display the fail bit map image of the column fail, the image data extracting unit 42 extracts the image data of the divided region where the fail bit corresponding to the column fail exists from the “column fail” directory of the second image data storage region 34. The image data extracting unit 42 refers to the management information to extract the identification number of the divided region where the fail bit corresponding to the column fail does not exist, and notifies the image data combining unit 43 of the identification number of the divided region.

The image data combining unit 43 creates the image data of the non-fail region from the identification number of the non-fail region, and combines the image data and the image data extracted by the image data extracting unit 42, thereby creating the fail bit map image. Therefore, the display unit 44 displays the fail bit map image of the column fail.

The second image data storage region 34 retains the fail bit map image data in each fail mode, so that the image data extracting unit 42 can rapidly extract the image data necessary for the fail mode-by-fail mode display of the fail bit map image. Therefore, the display unit 44 can rapidly perform the fail mode-by-fail mode display of the fail bit map image.

The second image data storage region 34 retains the fail bit map image data while the directory is divided in each fail mode, in each contraction level, and in each layer, so that the image data extracting unit 42 can rapidly extract the image data necessary for the fail bit map image of the fail mode-by-fail mode, the two-dimensional/three-dimensional display of the fail bit map image in which the plural fail modes are overlapped, the enlarged/reduced display, the layer-by-layer display, and the layer overlapping display. Therefore, the display unit 44 can rapidly switch the fail bit map image of the fail mode-by-fail mode, the two-dimensional/three-dimensional display of the fail bit map image in which the plural fail modes are overlapped, the enlarged/reduced display, the layer-by-layer display, and the layer overlapping display.

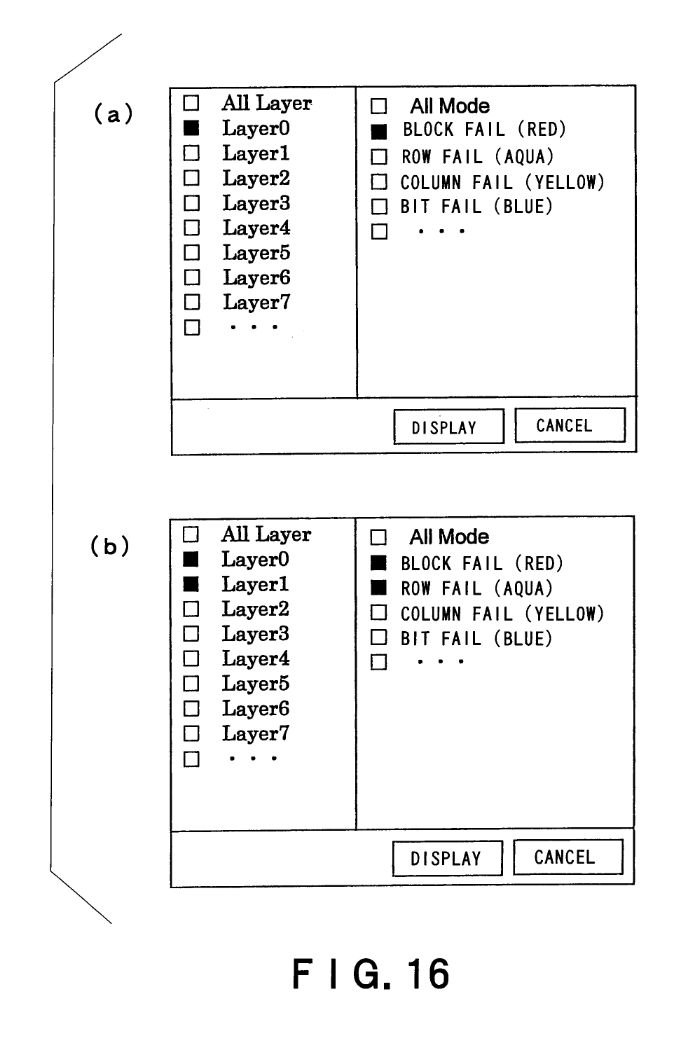

For example, as illustrated in FIG. 16(a), when the user provides an instruction to display the fail bit map image of the block fail in the layer 0, the image data extracting unit 42 extracts the image data of the divided region where the fail bit corresponding to the block fail exists from the “layer 0” directory in the “block fail” directory of the second image data storage region 34. The image data extracting unit 42 refers to the management information to extract the identification number of the divided region where the fail bit corresponding to the block fail does not exist, and notifies the image data combining unit 43 of the identification number of the divided region.

The image data combining unit 43 creates the image data of the non-fail region from the identification number of the divided region where the block fail does not exist and combines the image data and the image data extracted by the image data extracting unit 42, thereby creating the fail bit map image. Therefore, the display unit 44 can rapidly display the fail bit map image of the block fail in the layer 0.

In addition, for example, as illustrated in FIG. 16(b), when the user provides an instruction to display the fail bit map image of the block fail and row fail in the layer 0 and layer 1, the image data extracting unit 42 extracts the image data of the divided region where the fail bit corresponding to the block fail exists from the “layer 0” and “layer 1” directories in the “block fail” directory of the second image data storage region 34, and extracts the image data of the divided region where the fail bit corresponding to the row fail exists from the “layer 0” and “layer 1” directories in the “row fail” directory. The image data extracting unit 42 refers to the management information to extract the identification number of the divided region where the fail bit corresponding to the block fail and row fail does not exist, and notifies the image data combining unit 43 of the identification number of the divided region.

The image data combining unit 43 creates the image data of the non-fail region from the identification number of the divided region where the block fail does not exist and combines the image data and the image data extracted by the image data extracting unit 42, thereby creating the fail bit map image. Therefore, the display unit 44 can rapidly display the fail bit map image in which the block fail and row fail in the layer 0 and layer 1 are overlapped.

According to the embodiment, the fail bit map image can rapidly be displayed for the at least one fail mode and at least one layer, which are assigned by the user.

In the embodiment, a size per one file of the image data is reduced because the region dividing unit 12 of the fail bit data creating unit 10 performs the mesh division of one chip into the plural small regions. When the size per one file of the image data is reduced, the data is easily manipulated without generating swap even if the data compressed and retained in one file is expanded on the computer memory, and the fail bit map image can also rapidly be displayed.

According to the fail analysis system 1 of the embodiment, the two-dimensional/three-dimensional display of the fail bit map image, the enlarged/reduced display, the layer-by-layer display, the layer overlapping display, the fail mode-by-fail mode display, and the fail mode overlapping display can rapidly be performed to prevent the increase of inspection cost of a semiconductor device such as the three-dimensional structure memory.

In the embodiment, the image data creating unit 14 of the fail bit data creating unit 10 does not create the fail bit map image data of the whole bit fail region. Alternatively, the image data creating unit 14 may create the fail bit map image data of the whole bit fail region.

The pieces of image data creating processing performed by the image data creating units 14 and 22 are preferably performed with a multi-core processor. The multi-core processor concurrently performs the pieces of image data creating processing of the plural small regions, which allows the image data to be created in a short period of time.

In the embodiment, as illustrated in FIGS. 6, 7, 10, and 11, the directory is divided in each chip address and in each layer in the first image data storage region 32 and the second image data storage region 34. Alternatively, for example, like “5-5-Layer 0-#10.png”, the pieces of information on the chip address and layer may be included in the file name of the image data to decrease the number of hierarchies of the directory structure.

Besides, in the embodiment, as illustrated in FIGS. 10 and 11, the directory in which the layer is classified is provided below the directory in which the fail mode is classified in the second image data storage region 34. Alternatively, the directory in which the fail mode is classified may be provided below the directory in which the layer is classified according to the instruction of the user. For example, when the layer-by-layer display of the fail bit map image is frequently performed, the directory in which the layer is classified can be provided above to rapidly extract the image data.

Although the management information illustrated in FIG. 8 includes the identification number of the part bit fail region and the image file name, the identification number of the part bit fail region and the image file name may be omitted. This is because the fail bit map image data whose file name includes the identification number of the part bit fail region is stored in the first image data storage region 32.

In the embodiment, the fail analysis system 1 performs the fail analysis of the memory having the three-dimensional structure. However, in addition to the memory having the three-dimensional structure, the fail analysis system 1 can also perform the fail analysis of the semiconductor device having the three-dimensional structure and the memory having the two-dimensional structure.

At least part of the fail analysis system of the embodiment may be formed by hardware or software. When the fail analysis system is formed by the software, a program that realizes at least part of the function of the fail analysis system may be stored in a recording medium such as a flexible disk and a CD-ROM to cause the computer to read and execute the program. The recording medium is not limited to a detachable type recording medium such as a magnetic disk and an optical disk, but a fixed type recording medium such as a hard disk drive and a memory may be used as the recording medium.

The program that realizes at least part of the function of the fail analysis system may be distributed through a communication line (including wireless communication) such as the Internet. Further, the program may be distributed through the wired line and a wireless line such as the Internet while encrypted, modulated, or compressed, or in a storage medium.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fail analysis system for a semiconductor device, comprising:
an address converting unit that converts a logical fail bit map corresponding to a logical address of a semiconductor device including a plurality of layers each of which includes at least one chip into a physical fail bit map corresponding to a physical address of the semiconductor device;
a dividing unit that performs mesh division of the physical fail bit map to provide an identification number to a divided region;
a determining unit that determines whether the divided region is a first region where a fail bit does not exist, a second region where all bits are the fail bits, or a third region where a normal bit and the fail bit exist;
a first image data creating unit that creates first fail bit map image data for the divided region determined as the third region and performs contraction processing to the first fail bit map image data to create first contraction fail bit map image data;
a first image data storage unit in which the first fail bit map image data and the first contraction fail bit map image data are stored;
a specifying unit that specifies a kind of a fail mode corresponding to the fail bit based on a fail bit distribution shape in the physical fail bit map;
a second image data creating unit that creates second fail bit map image data for the divided region where the fail bit whose kind of the fail mode is specified exists and performs the contraction processing to the second fail bit map image data to create second contraction fail bit map image data;
a second image data storage unit in which the second fail bit map image data and the second contraction fail bit map image data are stored;
a management information storage unit in which first management information and second management information are stored, the first management information including identification numbers of the divided region determined as the first region and the divided region determined as the second region, the second management information including a correspondence relationship between the kind of the fail mode and the identification number of the divided region where the fail bit corresponding to the fail mode exists;
an instruction receiving unit that receives an instruction of a display format and/or a display region of the fail bit map image;
an extracting unit that extracts the first fail bit map image data, the first contraction fail bit map image data, the second fail bit map image data, or the second contraction fail bit map image data based on the instruction; and
a combining unit that combines the data extracted by the extracting unit and the first management information or the second management information to create a fail bit map image displayed on a display unit.

2. The fail analysis system for a semiconductor device according to claim 1, wherein the first image data creating unit and the second image data creating unit create the plurality of pieces of first contraction fail bit map image data and the plurality of pieces of second contraction fail bit map image data, the plurality of pieces of first contraction fail bit map image data differing from the plurality of pieces of second contraction fail bit map image data in a contraction ratio.

3. The fail analysis system for a semiconductor device according to claim 2, wherein the first fail bit map image data and the first contraction fail bit map image data are stored in the first image data storage unit while classified in each contraction ratio, in each chip, and in each layer, and
the second fail bit map image data and the second contraction fail bit map image data are stored in the second image data storage unit while classified in each kind of the fail mode, in each contraction ratio, in each chip, and in each layer.

4. The fail analysis system for a semiconductor device according to claim 1, wherein the first image data creating unit creates the first fail bit map image data and the first contraction fail bit map image data for only the divided region determined as the third region in the first to third regions.

5. The fail analysis system for a semiconductor device according to claim 1, wherein the first creating unit creates the first fail bit map image data and the first contraction fail bit map image data for only the divided region determined as the second region and the divided region determined as the third region in the first to third regions.

6. The fail analysis system for a semiconductor device according to claim 1, wherein, when the instruction receiving unit receives an instruction of fail mode-by-fail mode display or overlapping display of a plurality of kinds of the fail modes for at least one layer, the extracting unit extracts the second fail bit map image data or the second contraction fail bit map image data corresponding to the instructed layer and the instructed fail mode.

7. The fail analysis system for a semiconductor device according to claim 1, wherein the fail mode includes bit fail, column fail, row fail, and block fail.

8. A fail analysis method for a semiconductor device, in which a fail analysis system for a semiconductor device is used, the fail analysis system for a semiconductor device including:
an address converting unit that converts a logical fail bit map corresponding to a logical address of a semiconductor device including a plurality of layers each of which includes at least one chip into a physical fail bit map corresponding to a physical address of the semiconductor device;
a dividing unit that performs mesh division of the physical fail bit map to provide an identification number to a divided region;
a determining unit that determines whether the divided region is a first region where a fail bit does not exist, a second region where all bits are the fail bits, or a third region where a normal bit and the fail bit exist;
a first image data creating unit that creates first fail bit map image data for the divided region determined as the third region and performs contraction processing to the first fail bit map image data to create first contraction fail bit map image data,
a first image data storage unit in which the first fail bit map image data and the first contraction fail bit map image data are stored;
a specifying unit that specifies a kind of a fail mode corresponding to the fail bit based on a fail bit distribution shape in the physical fail bit map;
a second image data creating unit that creates second fail bit map image data for the divided region where the fail bit whose kind of the fail mode is specified exists and performs the contraction processing to the second fail bit map image data to create second contraction fail bit map image data;
a second image data storage unit in which the second fail bit map image data and the second contraction fail bit map image data are stored;
a management information storage unit in which first management information and a second management information are stored, the first management information including identification numbers of the divided region determined as the first region and the divided region determined as the second region, the second management information including a correspondence relationship between the kind of the fail mode and the identification number of the divided region where the fail bit corresponding to the fail mode exists; and
an image processing unit including an instruction receiving unit, an extracting unit, a combining unit, and a display unit,
the fail analysis method for a semiconductor device, comprising:
receiving an instruction of a display format and/or a display region of the fail bit map image using the instruction receiving unit;
extracting the first fail bit map image data, the first contraction fail bit map image data, the second fail bit map image data, or the second contraction fail bit map image data based on the instruction using the extracting unit;
combining the data extracted by the extracting unit and the first management information or the second management information to create a fail bit map image using the combining unit; and
displaying the fail bit map image created by the combining unit on the display unit.

9. The fail analysis method for a semiconductor device according to claim 8, wherein, when the instruction receiving unit receives an instruction of fail mode-by-fail mode display or overlapping display of a plurality of kinds of the fail modes for at least one layer, the extracting unit extracts the second fail bit map image data or the second contraction fail bit map image data corresponding to the instructed layer and the instructed fail mode.

10. The fail analysis method for a semiconductor device according to claim 9, wherein the display unit displays the fail bit map image with a different color in each fail mode.
